(19) United States
(12) Patent Application Publication
(10) Pub. No.: US 2019/0098141 A1
(43) Pub. Date: Mar. 28, 2019

(54) Systems and Methods for Providing Information on a Mobile Device

(71) Applicant: eBay Inc., San Jose, CA (US)

(72) Inventors: Bin Ni, Fremont, CA (US); Venu Reddy, San Jose, CA (US)

(73) Assignee: eBay Inc., San Jose, CA (US)

(21) Appl. No.: 16/201,760

(22) Filed: Nov. 27, 2018

Related U.S. Application Data
(63) Continuation of application No. 12/770,405, filed on Apr. 29, 2010.
(60) Provisional application No. 61/173,928, filed on Apr. 29, 2009.

(51) Int. Cl. G06Q 30/02; H04M 15/00; H04W 4/24

(52) U.S. Cl. CPC H04M 15/00; H04W 4/24; H04M 2215/82; G06Q 30/02; H04M 15/83; H04M 2215/81

(57) ABSTRACT

Example methods and systems described herein provide information on a mobile device. Some example embodiments may include receiving information that is current as of a specific period. The information may be subject to change with a progression of time. An example embodiment includes causing the received information to be output to a user interface of a mobile device at the same time that an element of a computing application is being output to the user interface. The element of the computing application may be associated with a computing application that is being executed by the mobile device.

### CLAIM OF PRIORITY

This application is a continuation of and claims priority to U. S. patent application Ser. No. 12/770,405, filed Apr. 29, 2010, entitled, “Systems And Methods For Providing Information on a Mobile Device”, which claims priority to U.S. Provisional Application Ser. No. 61/173,928, filed on Apr. 29, 2009, entitled, “Systems And Methods For Providing Information on a Mobile Device”, the disclosures of which are incorporated by reference herein.

### TECHNICAL FIELD

The present computing application relates generally to the technical field of network communications and, in one specific example, to providing information over a network to a machine such as a mobile device.

### BACKGROUND

There are a multitude of mobile devices used by consumers and workforces. Various hardware and software configurations may be employed to implement functionality provided by the multitude of mobile devices. Meanwhile, current or up-to-date information may be of interest to a user of a mobile device, even when the mobile device is executing a computing application and the user is interacting with the computing application.

### BRIEF DESCRIPTION OF THE DRAWINGS

Some embodiments are illustrated by way of example and not limitation in the figures of the accompanying drawings in which:

FIG. 1 is a block diagram illustrating a network environment within which method and system for providing information on a mobile phone may be implemented, in accordance with an example embodiment;

FIG. 2 is a flow diagram illustrating an example method for providing information on a mobile device, in accordance with an example embodiment;

FIG. 3 is a flow diagram illustrating an example method for providing targeted current information on a mobile device, in accordance with an example embodiment;

FIG. 4 is a block diagram showing a progression of visual displays via a display screen of a mobile device, in accordance with an example embodiment;

FIG. 5 is an interaction diagram illustrating example interactions between a mobile device and a machine, in accordance with an example embodiment;

FIG. 6 is a network diagram depicting a client-server system, within which one example embodiment may be deployed;

FIG. 7 is a block diagram illustrating multiple computing applications that, in one example embodiment, are provided as part of a networked system; and

FIG. 8 shows a diagrammatic representation of an example machine within which a set of instructions, for causing the machine to perform any one or more of the methodologies discussed herein, may be executed.

### DETAILED DESCRIPTION

Example methods and systems to provide information on a mobile device are described. In the following description, for purposes of explanation, numerous specific details are set forth in order to provide a thorough understanding of example embodiments. It will be evident, however, to one skilled in the art that the subject matter of the computing application may be practiced without these specific details.

There are currently many computing applications readily available to be installed and executed on mobile devices, such as mobile phones. Example computing applications may include games, social networking computing applications, business computing applications, and the like. Computing application developers for mobile devices may be incentivized to add advertisements to their computing applications such that the advertisements are available for viewing by a user who is at the same time experiencing the computing application itself In some example embodiments, a developer may be given affiliate status permitting the developer to be compensated each time a user interacts in some way with the advertisement embedded in the developer's computing application.

In some example embodiments, advertisements embedded within a computing application are updated, by a remote machine or server, to reflect current information associated with the goods or services being advertised. For example, the price of an item may be updated in an advertisement to reflect a change in price of the goods and/or services depending on its market value. Advertisements for some goods and/or services may be removed when the goods and/or services are no longer available. The advertisements for goods and/or services that have been removed may be replaced with advertisements for goods and/or services that are currently available for purchase. It may be noted that the embodiments described herein are not limited to providing advertisements for items for sale. Alternative or additional information that may be embedded in a computing application may include user location information, weather information, or any information that may change over a period and be updated.

In various example embodiments the information embedded within the computing application may be targeted to the user of the mobile device depending on the user's interaction with the mobile device, computing applications executing on the mobile device, the user's location, or any number of parameters that may be used to infer an interest or interests of the user. Processing of the various parameters may be performed by the mobile device itself or by a remote machine or server that receives the recorded user interactions from the mobile device.

In an example embodiment, current information pushed or pulled to a mobile device and presented to a user from within a computing application being used by the user may permit the user to constantly be informed of information of interest. Likewise, a party, such as an advertiser, wishing to reach consumers may be permitted to present goods or services to the consumer while the consumer is interacting or performing tasks using a computing application executing on the mobile device.

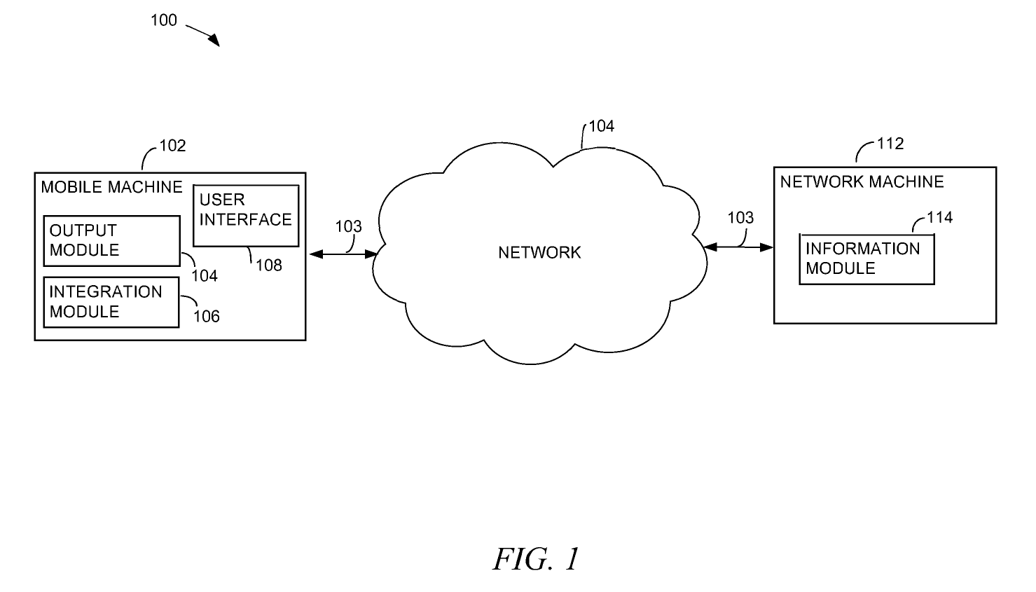

FIG. 1 is a block diagram illustrating a network environment 100, in accordance with an example embodiment. FIG. 1 is shown to include machines 102 and 112 coupled to a network 110 via transmission media 103. The machine 102 may be configured to process various instructions in order to perform one or more functions. In example embodiments, the machine 102 includes a central processing unit (CPU) to facilitate processing of the instructions. The machine 102 may be a mobile device such as a mobile phone that permits voice and data communications. Other mobile devices may include but not be limited to inventory tracking devices, delivery tracking devices, global positioning system (GPS) devices, or any other mobile device that receives and/or transmits information. The machine 102 is shown to include an output module 104, an integration module 106, and a user interface 108.

The output module 104 may be configured to provide a function including providing output to the user interface 108. In an example embodiment, the output module is a software script to output data to the user interface 108. Alternatively or additionally, the output module 104 may include instructions, that when executed, run an operating system and/or a computing application running within an operating system that outputs information (e.g., graphics) to the user interface 108. Example computing applications may include business related software, games, social networking computing applications, or any other typical software computing application known in the art to execute on a mobile device. In some example embodiments, instructions for the output module include software code specified for the machine 102 (e.g. a software development kit (SDK)).

The machine 102 is further shown to include an integration module 106. The integration module 106 may be configured to integrate received information with output from the output module 104, for presentation via the unit user interface 108. The integration module 106 is to receive information (e.g. a set of information that changes with time) from the machine 112 over the network 110, to cause the information to be provided to a user via the user interface 108, along with the output from the output module 104. In some example embodiments, instructions for the integration module 106 are embedded within instructions for the output module 104. The instructions may be embedded by a developer or be embedded via a plug-in installed by a user.

In some example embodiments, the integration module 106 may may be configured to initiate recordation of the user's interactions with the machine 102, location information, or other information related to a user's behavior or environment. The recorded information may be used to infer interests, wants, or needs of the user so that information related to the inferred interests, wants, or needs of the user may be delivered to the users machine 102. For example, the information related to a user's interest may be extracted from, or associated with, an online market or auction system.

The user-interface 108 may be configured to provide output that is perceived by a user. Various types of user-interfaces may include a display screen, and graphics display, audio and/or video output interface, Braille, motion provider, scent provider, or any other provider of output information that may be perceived by a user.

The network 110 is to provide communication between the machine 102 and the machine 112. In various example embodiments, the network 110 may include a wireless local area network (LAN) (e.g., implemented using WiFi), a wireless personal area network (PAN) such as a Bluetooth network, a wireless metropolitan area network (MAN) (e.g., implemented using WiMAX), a mobile device network (e.g., personal communication service (PCS) or global system for mobile communication (GSM)), or any other wireless network.

The machine 112, like the machine 102, is to process instructions to perform a function. In some example embodiments, the machine 112 is a desktop computer. In other example embodiments, the machine 112 is a mobile device such as the mobile device described above with respect to the machine 102. Example functions provided by the machine 112 may include the provision of Web services that provide services (e.g., function) in response to requests from the machine 102 or from other network devices. In some example embodiments, the machine 112 may request services from Web services provided by the machine 102 or other network devices.

The machine 112 is shown to include an information module 114. The information module 114 may be configured to provide a set of information items to the machine 102. The nature of the set of information items may be such that information within the set changes over time. For example, at a time T1, the set of information items may include information A, information B, and information C, but at time T2, the information in the set may have changed to then include information A′, information C′, and information E.

For various example embodiments, the information module 114 may include instructions that when executed generate the information and/or request the information from a different module being operated on the machine 112 and/or being operated on a different machine (not shown). Examples of information that by nature may vary or change with time may include but not be limited to commercial information such as price of an item offered for sale, bids for items offered for sale, items offered for sale, transaction status, time quantity, weather conditions, location information, audio and/or video information, news information, stock information, status information, and other time-affected information.

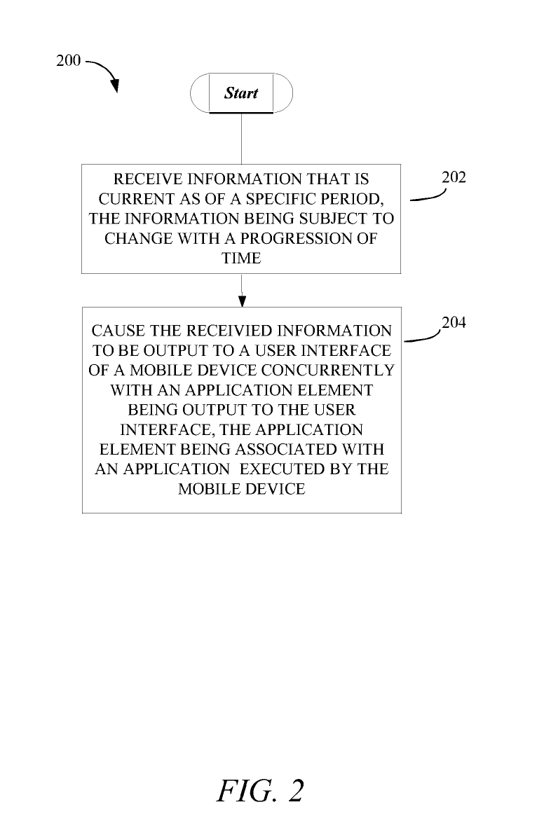

FIG. 2 is a flow diagram illustrating an example method 200 for providing information on a mobile device, in accordance with an example embodiment. In an example embodiment, the operations shown in blocks 202 and 204 may be performed by the integration module 106 of FIG. 1.

At block 202, the method 200 may include receiving information that is current as of a specific period, the information being subject to change with a progression of time. Referring to FIG. 1, integration module 106 may receive the current information from the information module 114 via the network 110. In example embodiment, the integration module 106 receives the current information after having requested the current information from the information module 114 (e.g., the information is pulled to the integration module 106). Alternatively or additionally, the integration module 106 may receive the current information without having requested the current information from the information module 114 (e.g., the current information is pushed to the integration module 106). Regardless of whether the current information is pushed from or pulled to the mobile device, the frequency of updates may range from subsecond updates to hourly daily or weekly updates, etc. In some example embodiments, the current information is current as of a specific period of time. For example, certain information may be considered to be current with respect to events occurring between 3 PM Pacific standard Time (PST) and 3:15 PM PST. The specific period may be associated with alternative or additional periodic occurrences such as measures of distance, volume, units, frequency, current, voltage, power, or any other unit of measure.

At block 204, the method 200 and may include causing the received information to be output to a user interface of a mobile device with a computing application element being output to the user interface. The computing application element may be associated with a computing application executed by the mobile device. Referring again to FIG. 1, the integration module 106 may, for example, integrate the received information (e.g., the current information) with the output of the output module 104 (e.g., a graphics display). In some example embodiments, the user interface 108 may include a display screen to display graphics output from the output module 104. In this example embodiment, the integration module 106 inserts the received information (e.g., items currently for sale) on a portion of the display screen normally reserved for the graphics output from the output module 104.

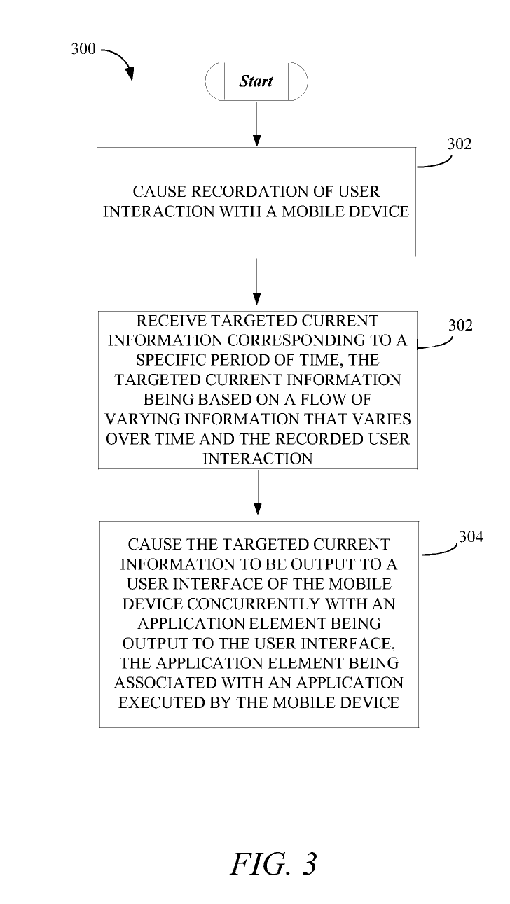

FIG. 3 is a flow diagram illustrating an example method 300 for providing targeted current information on a mobile device, in accordance with an example embodiment. In an example embodiment, the operations shown in blocks 302, 304, and 306 may be performed by the integration module 106 of FIG. 1.

At block 302, the method 300 may include causing recordation of user interaction with the mobile device. The integration module 106 of FIG. 1 may be configured to record certain interactions that a user has with the machine 102 of FIG. 1. As noted above with respect to the integration module 106 of FIG. 1, recorded information may be used to infer interests of a user controlling the machine 102. In an example embodiment, information used to infer interests of the user includes the names of the computing applications being run on the machine 102, the computing application related functions initiated by the user of the machine 102, and the websites visited by the user of the machine 102. Other information that may indicate interest may include location information obtained by the machine 102. In an example embodiment information of interest may be recorded on the machine 102 and processed on the machine 102 to infer the user's interests. Subsequently, the integration module 106 may request targeted current information from the information module 114. Alternatively or additionally, the information of interest may be transmitted to the machine 112 where the information module 114 or other modules may process the information of interest to ascertain interests of the user of the machine 102.

At block 304, the method 300 may include receiving targeted current information corresponding to a specific period of time. The current information may be based on a flow of sharing information that varies over time and further based on the recorded user interaction. Referring to FIG. 1, information module 114 may deliver the targeted current information, after having obtained it, to the integration module 106.

At block 306, the method 300 may include causing the targeted current information to be output to a user interface of the mobile device with a computing application element also being output to the user interface. The computing application element may be associated with a computing application executed by the mobile device. In FIG. 1, integration module 106 may perform similar functionality as described above with respect to block 204 FIG. 2, except that block 306 of FIG. 2 indicates that the integrated information is targeted current information.

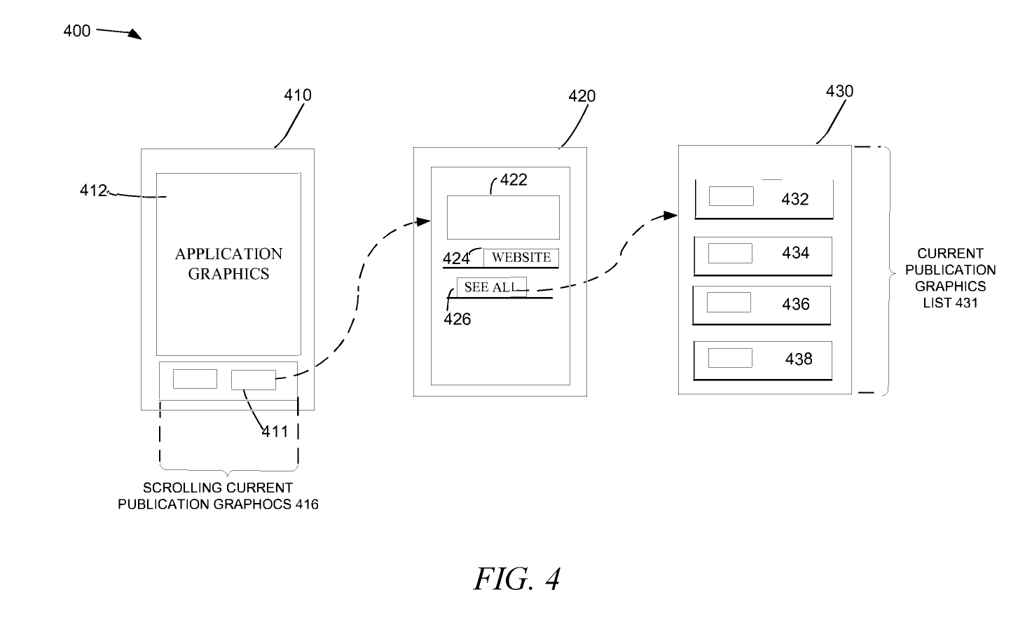

FIG. 4 is a block diagram showing a progression 400 of views presented on a display screen of a mobile device, in accordance with an example embodiment. The mobile device 102 may be an example embodiment of the machine 102 of FIG. 1. Views 410, 420, and 430 may be presented, at different times, by the user interface 108 of the mobile machine 102 of FIG. 1. The view 410 includes computing application graphics 412 and scrolling current publication graphics 414. The computing application graphics 412 may represent output from the output module 104 of FIG. 1. The computing application graphics 412 may include one or more frames making up a visual presentation associated with a computing application being executed by the mobile device 102. The scrolling current publication graphics 414 may represent the current information (and, in some embodiments, targeted information) received from the information module 114 of FIG. 1. In some example embodiments, publication information such as the publication information of a frame 416 may include an advertisement for an item being sold via a website. The frame 416 in which the publication information is provided may be selectable to initiate the display of further information associated with the publication information.

The view 420 shown in the middle of FIG. 4 includes additional current publication information 422, a frame 424 that is selectable to navigate to a website associated with the current publication information 422, and a frame 426 that is selectable to initiate the display of all of the current publication graphics by the user interface 108. In an example embodiment, the additional current publication information 424 may include details about the item offered for sale such as item description, a current bidder, a photograph of the item, or any additional information about the item. If a user is interested in navigating to a source of the current publication information 422 (e.g., in order to purchase the item), the user may interact with the frame 424 to cause the mobile device 102 to open a browser and receive a webpage associated with the source of the publication information provided in the frame 416. In one example embodiment, the user may purchase the advertised item through the website. If a user wishes to see the scrolling current publication graphics 414 (shown in the view 410) in list form, the user may interact with the frame 426 (that may be labeled “SEE ALL”) to view the current publication graphics list 431 shown in the view 430.

The view 430 shows the list of current publication graphics 412. Lists shown to include current publication graphics 431 that comprises frames 432, 434, 436, and 438, each of which may be selectable to view additional information about the current publication as described with respect to the additional current publication information 422.

It will be noted that the scrolling current publication graphics 414, the additional current publication information 422, the website frame 424, the frame 426, and the current publication graphics list 431 may each be implemented and caused to be displayed by the computing application outputting the computing application graphics 412. In some example embodiments, the code that is executed to display the current publication information related graphics may be embedded within the code of the computing application itself

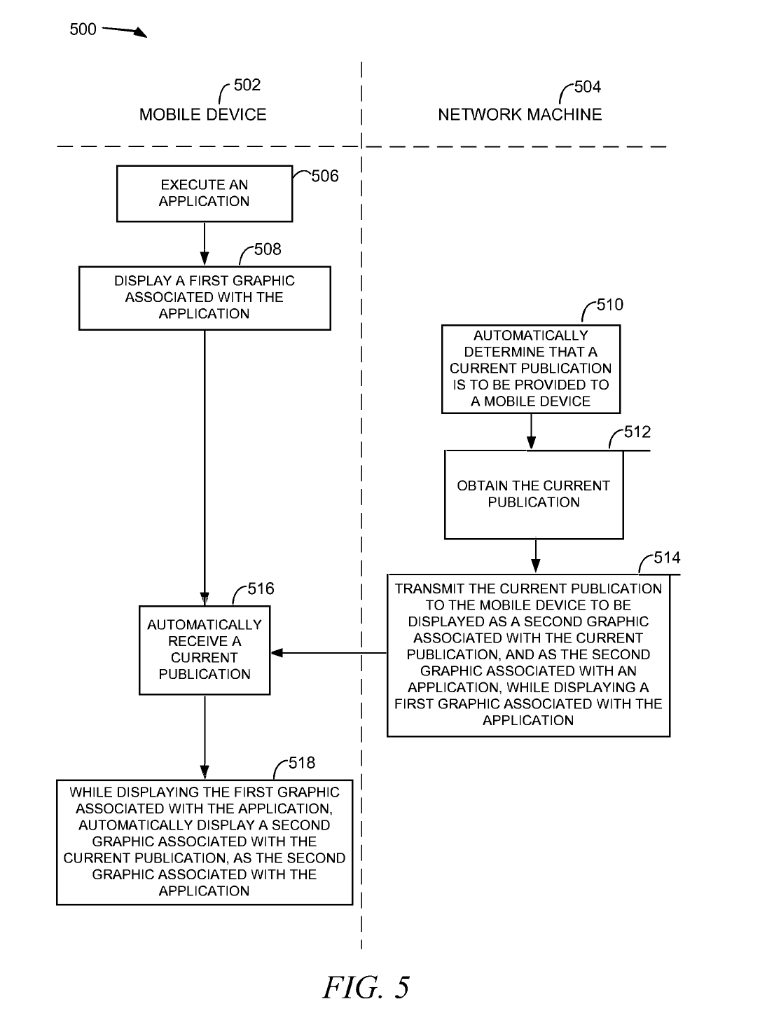

FIG. 5 is an interaction diagram 500 illustrating example interactions between a mobile device 502 and a machine 504, in accordance with an example embodiment. In describing the interactions below, the mobile device 502 may be substantially similar to the mobile device 102 of FIGS. 1 and 4, and the machine 504 may be substantially similar to the machine 112 of FIG. 1.

At block 506, the interaction 500 may include the mobile device 502 performing the operation of executing a computing application, and at block 508 displaying a first graphic associated with the computing application as shown in FIG. 4 as the computing application graphics 412.

At block 510, the interaction 500 may include the machine 504 determining that a current publication is to be provided to a mobile device. As described above with respect to FIG. 1, current publication information may be pushed or pulled to the mobile device 502. In either event, the determination that the current publication is to be provided may be made automatically, without human intervention.

At block 512, the interaction 500 may include machine 504 obtaining the current publication. Some example embodiments of machine 504 may access a local database to obtain the current publication. Alternatively or additionally, the current publication may be obtained from a remote machine that is connected to the machine 504 via a network.

At block 514, the interaction 500 may include the machine 504 transmitting the current publication to the mobile device to be displayed as a second graphic associated with the current publication. The graphic associated with the publication may also be considered a second graphic associated with a computing application while the machine 504 is displaying first graphic associated with the computing application.

At block 516, the interaction 500 may include the mobile device 502 automatically receiving a current publication and at block 518 the mobile device 502, while displaying the first graphic associated with the computing application, may automatically display second graphic associated with the current publication as a second graphic associated with the computing application.

The example embodiment of the result of the operations described at block 518 is shown as the view 410 in FIG. 4, displaying the computing application graphics 412 in the scrolling current publication graphics 414. As illustrated in the view 420 in FIG. 4, a computing application may be executing in the background, such that computing application graphics 412 are not visible. As described above, the computing application generates the display of the current publication-related graphics 414, 422, 424, 426, and 431 with or without also displaying the computing application graphics 412.

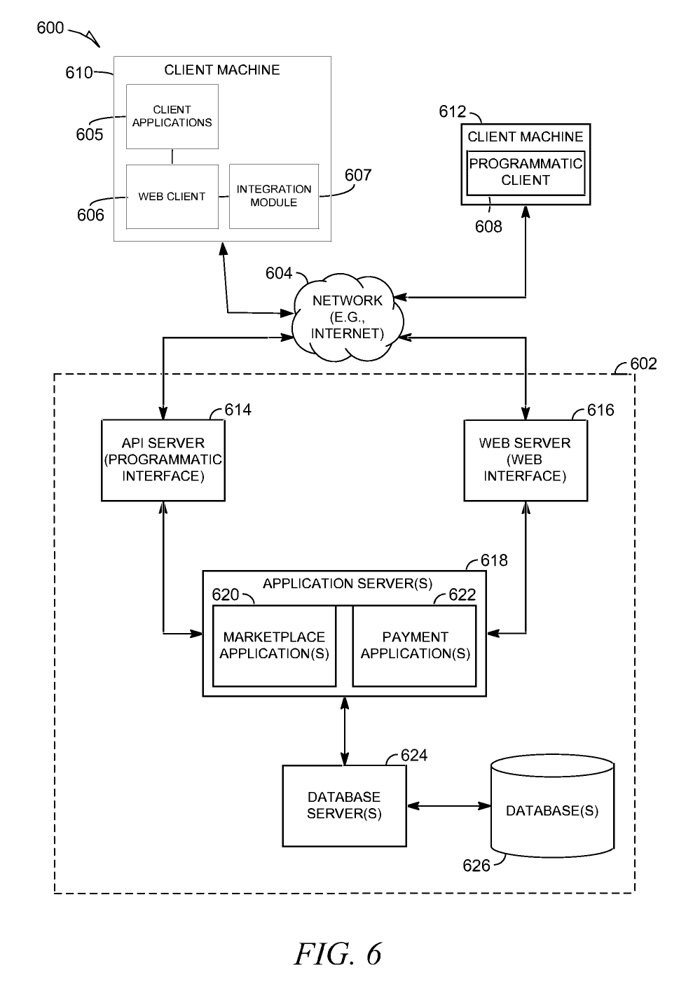

FIG. 6 is a network diagram depicting a client-server system 600, within which one example embodiment may be deployed. A networked system 602, in the example forms of a network-based marketplace or publication system, provides server-side functionality, via a network 604 (e.g., the Internet or Wide Area Network (WAN)) to one or more clients. FIG. 6 illustrates, for example, client applications 605 (e.g., mobile applications), an integration module 607, and a web client 606 (e.g., a mobile or desktop Web browser) operating on the client machine 610 (e.g., a mobile device), as well as a programmatic client 608 operating on the client machine 612.

A application Program Interface (API) server 614 and a web server 616 are coupled to, and provide programmatic and web interfaces respectively to, one or more application servers 618. The application servers 618 host one or more marketplace applications 620 and payment applications 622. The application servers 618 are, in turn, shown to be coupled to one or more databases servers 624 that facilitate access to one or more databases 626.

The marketplace applications 620 may provide a number of marketplace functions and services to users that access the networked system 602. The payment applications 622 may likewise provide a number of payment services and functions to users. The payment applications 622 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 620. While the marketplace and payment applications 620 and 622 are shown in FIG. 6 to both form part of the networked system 602, it will be appreciated that, in alternative embodiments, the payment applications 622 may form part of a payment service that is separate and distinct from the networked system 602.

Further, while the system 600 shown in FIG. 6 employs client-server architecture, the subject matter of the application is of course not limited to such an architecture, and could equally well find application in a distributed, or peer-to-peer, architecture system, for example. The various marketplace and payment applications 620 and 622 could also be implemented as standalone software programs, which do not necessarily have networking capabilities.

The web client 606 accesses the various marketplace and payment applications 620 and 622 via the web interface supported by the web server 616. Similarly, the programmatic client 608 accesses the various services and functions provided by the marketplace and payment applications 620 and 622 via the programmatic interface provided by the API server 614. The programmatic client 608 may, for example, be a seller application (e.g., the TurboLister application developed by eBay Inc., of San Jose, Calif.) to enable sellers to author and manage listings on the networked system 602 in an off-line manner, and to perform batch-mode communications between the programmatic client 608 and the networked system 602.

The integration module 607 on the client machine (e.g., a mobile phone) may submit requests to the marketplace applications 610, through the API server 614, for an up-to-date (e.g., current) publication related to goods and/or services being offered for sale via the networked system 602. Alternatively or additionally the client machine 610 may request one or more current publications from the client machine 612, via the network 104. In various example embodiments, the client machine 612 may provide a current publication to the client machine 610, after generating the current publication or retrieving such a publication from the networked system 602.

In some example embodiments, the integration module is embedded within one or more of the client applications 605 and may collect user parameters, receive targeted current publications based on the user parameters, and cause the display of one or more targeted current publications. A targeted current publication may be displayed among graphics associated with the application in which the integration module is embedded (e.g., see FIG. 4).

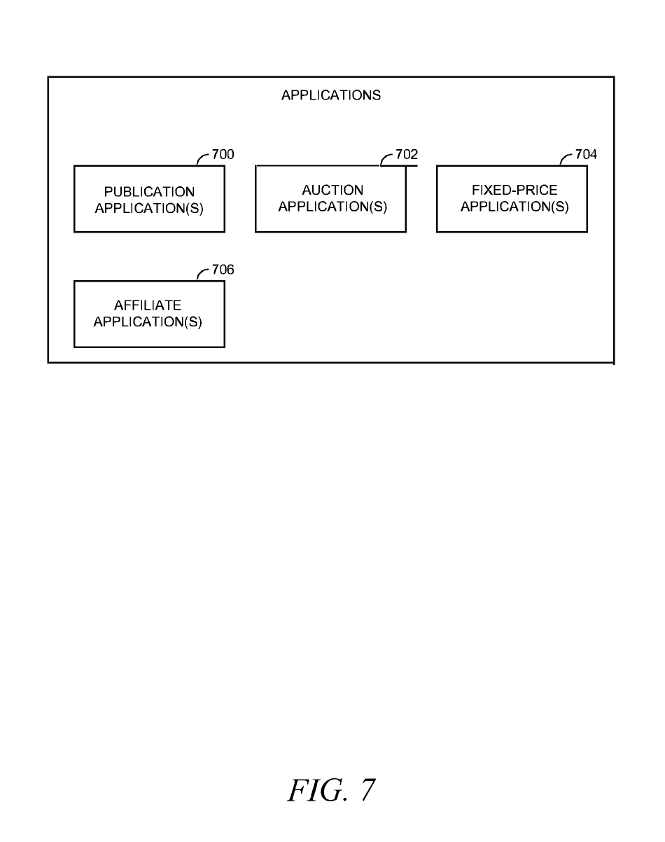

FIG. 7 is a block diagram illustrating multiple applications 620 and 622 that, in one example embodiment, are provided as part of the networked system 602. The applications 620 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 626 via the database servers 628.

The networked system 602 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 620 are shown to include at least one publication application 700 and one or more auction applications 702 which support auction-format listing and price setting mechanisms (e.g., English, Dutch, Vickrey, Chinese, Double, Reverse auctions etc.). The publication applications 700 may provide up-to-date publications to the client machine 610 of FIG. 6 without an external request or in response to a request from the integration module 605 of FIG. 6. The various auction applications 702 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 704 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 706 allow a seller to group listings within a “virtual” store, which may be branded and otherwise personalized by and for the seller. Such a virtual store may also offer promotions, incentives and features that are specific and personalized to a relevant seller.

Reputation applications 708 allow users that transact, utilizing the networked system 602, to establish, build and maintain reputations, which may be made available and published to potential trading partners. Consider that where, for example, the networked system 602 supports person-to-person trading, users may otherwise have no history or other reference information whereby the trustworthiness and credibility of potential trading partners may be assessed. The reputation applications 708 allow a user, for example through feedback provided by other transaction partners, to establish a reputation within the networked system 602 over time. Other potential trading partners may then reference such a reputation for the purposes of assessing credibility and trustworthiness.

Personalization applications 710 allow users of the networked system 602 to personalize various aspects of their interactions with the networked system 602. For example a user may, utilizing an appropriate personalization application 710, create a personalized reference page at which information regarding transactions to which the user is (or has been) a party may be viewed. Further, a personalization application 710 may enable a user to personalize listings and other aspects of their interactions with the networked system 602 and other parties.

Affiliate applications 706 provide the formation, and operation of an affiliate program that includes compensation for affiliates who post advertisements on behalf of the networked system 602 of FIG. 6. For example, a third-party who designs applications for a mobile device such as the client machine 610 of FIG. 6 may be incentivized by the affiliate program to embed the integration module 607 of FIG. 6 into one of the developer's applications to permit networked system 602 advertisements to be shown while the developer's application is open and being displayed.

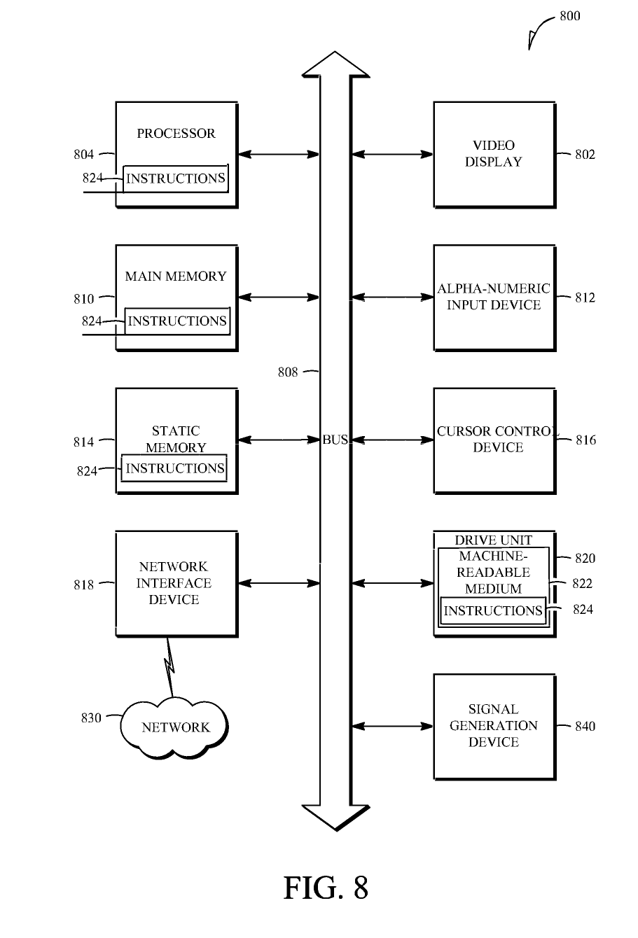

FIG. 8 shows a diagrammatic representation of machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU) a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the subject matter of the computing application. The term “machine-readable medium” shall accordingly be taken to include, but not be limited to, solid-state memories, optical and magnetic media, and carrier wave signals.

Thus, a method and system to provide information on a mobile device have been described. Although the subject matter of the computing application has been described with reference to specific example embodiments, it will be evident that various modifications and changes may be made to these embodiments without departing from the broader spirit and scope of the subject matter of the computing application. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. (canceled)

2. A method comprising:
receiving information associated with a user interaction with a computing device on which an application is executing;
based on said information, identifying targeted information associated with an item for sale on an online market or online auction system, the targeted information to be included within a frame of the application, the targeted information including a set of commercial information items associated with the item for sale, the set of commercial information items including first information that changes over time and second information that does not change over time while the targeted information is displayed within the frame;
sending, to the frame, instructions to display the targeted information; and
sending, to the frame, instructions to update the first information while the targeted information is displayed within the frame.

3. The method of claim 2, wherein the first information comprises a value representing a price of an item offered for sale or a value representing a bid for an item offered for sale.

4. The method of claim 2, wherein said sending instructions to update is performed responsive to a request from the computing device.

5. The method of claim 2, wherein said receiving information comprises receiving one or more of: names of computing applications being run on the computing device, computing application related functions initiated by the user, or websites visited by the user.

6. The method of claim 2, wherein the frame is selectable to initiate display of further information associated with the item for sale.

7. The method of claim 6, wherein the further information associated with the item for sale includes a selectable frame that is selectable to cause a navigation to a webpage associated with the online market or online auction system.

8. The method of claim 2, wherein the application comprises one of a business computing application, a social networking computing application, or a computer game.

9. A computer-implemented system comprising:
one or more processors;
a non-transitory computer readable storage medium comprising storing instructions that, when executed by the one or more processors, cause the one or more processors to perform operations comprising:
receiving information associated with a user interaction with a computing device on which an application is executing;
based on said information, identifying targeted information associated with an item for sale on an online market or online auction system, the targeted information to be included within a frame of the application, the targeted information including a set of commercial information items associated with the item for sale, the set of commercial information items including first information that changes over time and second information that does not change over time while the targeted information is displayed within the frame;
sending, to the frame, instructions to display the targeted information; and
sending, to the frame, instructions to update the first information while the targeted information is displayed within the frame.

10. The computer-implemented system of claim 9, wherein the first information comprises a value representing a price of an item offered for sale or a value representing a bid for an item offered for sale.

11. The computer-implemented system of claim 9, wherein said sending instructions to update is performed responsive to a request from the computing device.

12. The computer-implemented system of claim 9, wherein said receiving information comprises receiving one or more of: names of computing applications being run on the computing device, computing application related functions initiated by the user, or websites visited by the user.

13. The computer-implemented system of claim 9, wherein the frame is selectable to initiate display of further information associated with the item for sale.

14. The computer-implemented system of claim 13, wherein the further information associated with the item for sale includes a selectable frame that is selectable to cause a navigation to a webpage associated with the online market or online auction system.

15. A non-transitory storage medium having executable instructions to perform operations comprising:
receiving information associated with a user interaction with a computing device on which an application is executing;
based on said information, identifying targeted information associated with an item for sale on an online market or online auction system, the targeted information to be included within a frame of the application, the targeted information including a set of commercial information items associated with the item for sale, the set of commercial information items including first information that changes over time and second information that does not change over time while the targeted information is displayed within the frame;
sending, to the frame, instructions to display the targeted information; and
sending, to the frame, instructions to update the first information while the targeted information is displayed within the frame.

16. The non-transitory storage medium of claim 15, wherein the first information comprises a value representing a price of an item offered for sale or a value representing a bid for an item offered for sale.

17. The non-transitory storage medium of claim 15, wherein said sending instructions to update is performed responsive to a request from the computing device.

18. The non-transitory storage medium of claim 15, wherein said receiving information comprises receiving one or more of: names of computing applications being run on the computing device, computing application related functions initiated by the user, or websites visited by the user.

19. The non-transitory storage medium of claim 15, wherein the frame is selectable to initiate display of further information associated with the item for sale.

20. The non-transitory storage medium of claim 19, wherein the further information associated with the item for sale includes a selectable frame that is selectable to cause a navigation to a webpage associated with the online market or online auction system.

21. The non-transitory storage medium of claim 15, wherein the application comprises one of a business computing application, a social networking computing application, or a computer game.
